(19) United States
(12) Patent Application Publication
(10) Pub. No.: US 2026/0163990 A1
(43) Pub. Date: Jun. 11, 2026

(54) SCANNING DEVICE AND HOMING METHOD OF SCANNING DEVICE

(71) Applicant: KINPO ELECTRONICS, INC., NEW TAIPEI CITY (TW)

(72) Inventors: Bor-Chih CHUANG, NEW TAIPEI CITY (TW); Yung-Sen CHENG, NEW TAIPEI CITY (TW)

(21) Appl. No.: 19/034,585

(22) Filed: Jan. 23, 2025

(30) Foreign Application Priority Data
Dec. 6, 2024 (TW) 113147521

(51) Int. Cl. H04N 1/047; G06T 7/73

(52) U.S. Cl. CPC H04N 1/047; G06T 7/73; G06T 2207/10008; H04N 2201/04713; H04N 2201/04715

(57) ABSTRACT

A scanning device includes a scanning module and a positioning pattern. The positioning pattern is disposed on outside of a scanning window along a moving-scan cycle direction. A first block of the positioning pattern is associated with a positioning location, and a second block is associated with a starting-scan location. After the scanning module moves a first stepping distance toward the positioning location, an acquired feature of a current location is detected; when the acquired feature of the current location is the same as a pattern feature of the second block, the scanning module switches to moving a second stepping distance toward the positioning location. When the scanning module determines that the acquired feature of the current location is the same as the pattern feature of the first block, the scanning module stops at the positioning location.

### BACKGROUND OF THE DISCLOSURE

### Technical Field

The technical field generally relates to a scanning device and a control method thereof, and particularly to a scanning device and a homing method of the scanning device.

### Description of Related Art

After a scanning device finishes scanning operations, the scanning module needs to return to the home location, such that the scanning module starts at the fixed home location each time to confirm the consistent scan region in each scanning process. The conventional scanning device is equipped with an extended structure and a sensor. When the scanning module moves to a specific location such that the extended structure blocks the sensor, the scanning device determines that the scanning module has returned to the home location, and the scanning module completes the homing process. However, the approach requires additional hardware components installed on the scanning device, and it results in additional hardware costs. Furthermore, the additional hardware components occupy the internal space of the scanning device for the homing process of the scanning module, so the volume of the scanning device cannot be reduced.

Therefore, how to improve the design of the scanning device, and based on simplifying the structure of the scanning device, how to confirm the scanning module to accurately return to the home location, is a notable problem that deserves to be given attention.

### SUMMARY OF THE INVENTION

The disclosure is directed to a scanning device including a scanning module and a positioning pattern. The scanning module moves along a moving-scan cycle direction. The positioning pattern is disposed on outside of a scanning window along a moving-scan cycle direction. The positioning pattern includes a first block, a second block, and at least one third block. The first block is associated with a positioning location, the second block is associated with a starting-scan location, and the first block, the second block and the at least one third block are consecutive adjacent blocks with different pattern features. After moving a first stepping distance toward the positioning location, the scanning module detects an acquired feature of a current location, and when the acquired feature of the current position is same as the pattern feature of the second block, the scanning module switches to moving a second stepping distance toward the positioning location to detect the acquired feature of the current location. Then the scanning module detects the acquired feature of the current location, and when the acquired feature of the current position is same as the pattern feature of the first block, the scanning module determines the current location is at the positioning location and stops at the positioning location.

One of the exemplary embodiments is directed to a homing method of a scanning device, where the scanning device includes a scanning module moving along a moving-scan cycle direction. The homing method includes disposing a positioning pattern on the outside of a scanning window along the moving-scan cycle direction, where the positioning pattern includes a first block, a second block, and at least one third block, the first block is associated with a positioning location, and the second block is associated with a starting-scan location. The first block, the second block, and the at least one third block are consecutive adjacent blocks with different pattern features. The homing method further includes moving by the scanning module a first stepping distance toward the positioning location and detecting an acquired feature of a current location of the scanning module; determining by the scanning module whether the acquired feature of the current location is the same as the pattern feature of the second block and switching to moving a second stepping distance toward the positioning location to detect the acquired feature of the current location, then detecting by the scanning module the acquired feature of the current location, and determining the acquired feature of the current location being same as the pattern feature of the first block, and determining the current location being at the positioning location to stop at the positioning location.

### BRIEF DESCRIPTION OF THE DRAWINGS

FIG. 1 is a top view of a scanning module of a scanning device according to an embodiment of the disclosure.

FIG. 2 is a top view of the scanning device having a positioning pattern according to an embodiment of the disclosure.

FIG. 3 is a side view of the scanning device according to an embodiment of the disclosure.

FIG. 4 is a top view after the scanning module of FIG. 2 moves a first stepping distance.

FIG. 5 is a top view after the scanning module moves one or more second stepping distances.

FIG. 6 is a top view of the scanning device having the positioning pattern according to an embodiment of the disclosure.

FIG. 7 is a top view of the scanning device having the positioning pattern according to another embodiment of the disclosure.

FIG. 8 is a flowchart of a homing method of the scanning device according to an embodiment of the disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

A scanning device finishes scanning operations each time performs a homing process, so a scanning module returns to a positioning location to ensure that the scanning module starts to move from a fixed reference point at each new scanning process. In addition, after several times of scanning processes, the scanning module might deviate from a predetermined location because of the mechanical jitter, hence the homing process may prevent the scanning module from deviation after long time operations.

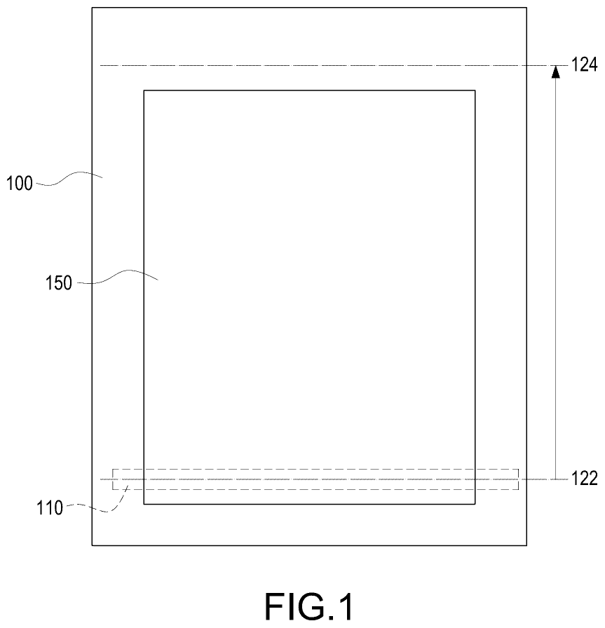

Reference is made to FIG. 1. FIG. 1 is a top view of a scanning module of a scanning device according to an embodiment of the disclosure.

A scanning device 100 includes a scanning module 110 and a scanning window 150. The scanning module 110 is disposed below the scanning window 150 along a horizontal plane of the scanning window 150 to sense documents being horizontally placed on the scanning window 150. The scanning window 150 may be a transparent window that allows lights to enter the scanning module 110 and restricts the scanning boundary of the scanning module 110.

The scanning module 110 includes optical components (such as Light-Emitting Diodes (LED)), sensors (such as Charge-Coupled Devices (CCD) or Complementary Metal-Oxide-Semiconductors (CMOS)), and drive mechanisms (such as step motors) (not shown in figures).

As shown in FIG. 1, a positioning location 124 is a reference point location of the scanning module 110 returning a home location. When the scanning device 100 starts to perform the scanning operation, the scanning module 110 moves from the starting point, that is, the positioning location 124. The starting-scan location 122 is the location after the scanning module 110 finishes the scanning operation and moves back to the positioning location 124 at a relatively fast speed, and the process is called a “homing operation”.

The scanning device 100 may perform the scanning operation and the homing operation. The scanning module 110 starts the scanning operation from the positioning location 124, moves below the scanning window 150, and acquires scanning data. After finishing the scanning operation, the scanning module 110 is at a stopping-scan location. In the meantime, the scanning module 110 takes the stopping-scan location as the starting-scan location 122 and moves towards the positioning location 124, and then the scanning module 110 stops at the positioning location 124 to complete the homing process.

Before the scanning module 110 returns the positioning location 124, it requires a demand of continuously sensing from the starting-scan location 122 and determining whether to move to the positioning location 124. Because the starting-scan location 122 and the positioning location 124 are two opposite sides of the scanning window 150, it takes time for the scanning module 110 to move from one side of the scanning window 150 to another.

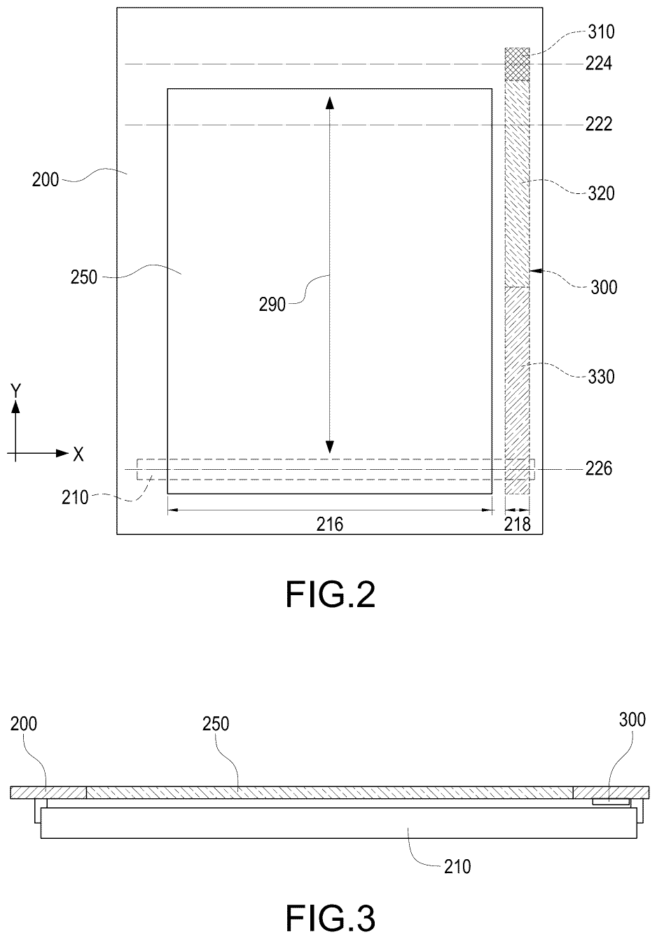

Reference is made to FIG. 2. FIG. 2 is a top view of the scanning device having a positioning pattern according to an embodiment of the disclosure.

A scanning module 210 of a scanning device 200 moves along a moving-scan cycle direction 290, performing the scanning operation and the homing operation. The moving-scan cycle direction 290 may be the direction to and from the positioning location 224 and the stopping-scan location 226. For example, the scanning module 210 moves from the positioning location 224 and performs the scanning operation until moving to the stopping-scan location 226 and finishing the scanning operation. Then, the scanning module 210 moves from the stopping-scan location 226 to the positioning location 224 and completes the homing process.

When the scanning device 200 finishes the scanning operation, the scanning module 210 is at the stopping-scan location (not numbered in FIG. 1). The scanning module 110 of FIG. 1 regards the stopping-scan location as the starting-scan location 122 and performs the homing operation during moving toward the positioning location 124 to go back the homing position. In contrast, after finishing the scanning operation, the scanning module 210 of FIG. 2 quickly moves from the stopping-scan location 226 to the starting-scan location 222 and then starts detection of the positioning location 224 from the starting-scan location 222 to complete the homing operation of the scanning module 210. Therefore, the homing operation of FIG. 2 may reduce the time consumption of moving between the stopping-scan location 226 and the starting-scan location 222 and the time of image analysis during the movement.

In one embodiment, the scanning device 200 has a positioning pattern 300. The positioning pattern 300 is disposed on the outside of a scanning window 250 and along a moving-scan cycle direction 290. For example, the positioning pattern 300 is arranged adjacent to the outside of the scanning window 250 without affecting the scanning operation of the scanning module 210 scanning the documents through the scanning window 250. In one embodiment, when the scanning module 210 performs the scanning operation, the positioning pattern 300 arranged outside the scanning window 250 will not be outputted as part of the scanned data.

The positioning pattern 300 may be a strip shape and parallel to the moving-scan cycle directions. The length of a scan line of the scanning module 210 is greater than the length of the scanning window 250 (in the X direction) and extends a certain length outside the scanning window 250. In one embodiment, the scan line of the scanning module 210 includes a scanning segment 216 and a redundant segment 218. The scanning segment 216 is the scan track width of the output scanned data when the scanning module 210 performs the scanning operation. The redundant segment 218 is the scan track width of sensing the positioning pattern 300 when the scanning module 210 performs the homing operation. When the scanning device 200 performs the homing operation, the scanning module 210 only senses the contents (i.e., the redundant segment 218) of the scan line outside the scanning window 250.

Reference is made to FIG. 3. FIG. 3 is a side view of the scanning device according to an embodiment of the disclosure.

The document (not shown in the figures) may be placed on the horizontal plane of the scanning window 250 of the scanning device 200. The moving-scan cycle direction of the scanning module 210 is the direction perpendicular to the plane of the paper in FIG. 3. As shown in FIG. 3, the scanning module 210 is disposed below the horizontal plane of the scanning window 250 and, in the way of the sensing side facing upwards, scans the document through the scanning window 250 along the moving-scan cycle direction.

The positioning pattern 300 is disposed outside the scanning window 250 and the scan line of the scanning module 210 covers the width of the scanning window 250 and the width of the positioning pattern 300. In one embodiment, the positioning pattern 300 is adjacent to the outside of the scanning window 250, so the scan line of the scanning module 210 covers part or all of the positioning pattern 300.

Referring to FIG. 2, the positioning pattern 300 includes a first block 310, a second block 320, and at least one third block 330. The first block 310, the second block 320, and the at least one third block 330 are contiguously adjacent with different pattern features.

The contiguously adjacent blocks indicate that the first block 310 is adjacent to the second block 320, the second block 320 is adjacent to the first of the third block 330, the second of the third block 330 is adjacent to the first of the third block 330, and so on.

The embodiment of FIG. 2 takes one third block 330 as an illustrative example, and the quantity of the third block is not limited herein.

In one embodiment, the first block 310 of the positioning pattern 300 is associated with the positioning location 224, and the second block 320 of the positioning pattern 300 is associated with starting-scan location 222. The “first block 310 of the positioning pattern 300 is associated with the positioning location 224” indicates that, when the scanning module 210 moves in the area of the first block 310 and detects the pattern feature of the first block 310, the scanning module 210 determines that it has moved at the positioning location 224 and stops moving. The “second block 320 of the positioning pattern 300 is associated with starting-scan location 222” indicates that, when the scanning module 210 moves in the area of the second block 320 and detects the pattern feature of the second block 320, the scanning module 210 performs a short-distance movement and performs the process of detecting and capturing features until the scanning module 210 moves in the area of the first block 310.

The following is about the detailed operations after finishing the scanning operation, such as the detailed operations that the scanning module 210 performs a first homing detection to move to the starting-scan location 222 from the stopping-scan location 226, and then performs a second homing detection from the starting-scan location 222 to complete the homing process of the scanning module 210.

After finishing the scanning operation, the scanning module 210 is at the stopping-scan location 226. Then, the scanning module 210 moves a first stepping distance towards the positioning location 224 and senses an image with a pixel quantity to detect an acquired feature of the current location of the scanning module 210 (the first homing detection). If the acquired feature of the current location is the same as the pattern feature of the second block 320, the scanning module 210 switches to moving a second stepping distance towards the positioning location 224 and senses the image with the pixel quantity to detect the acquired feature of the current location of the scanning module 210 (the second homing detection). If the acquired feature of the scanning module 210 is the same as the pattern feature of the first block 310, the scanning module 210 determines that the current location is within the positioning location 224 and stops at the positioning location 224 to complete the homing process.

In one embodiment, the first stepping distance is the same as the length of the third block 330. For example, the scanning module 210 moves a distance the same as the length of the third block 330 from the stopping-scan location 226 towards the positioning location 224. In the first homing detection, because the stopping-scan location 226 is within the area of the third block 330, the scanning module 210 enters the area of the second block 320 after the movements of the first stepping distance.

In one embodiment, the second stepping distance is the same as the length of the first block 310. For example, in the second homing detection, after the scanning module 210 moves within the area of the second block 320, the scanning module 210 moves a distance the same as the length of the first block 310 and detects the acquired feature of the current location. If the acquired feature of the current location is different from the pattern feature of the first block 310, the scanning module 210 continuously steps forward the distance the same as the first block 310 until the acquired feature of the current location is the same as the pattern feature of the first block 310.

In one embodiment, the first stepping distance is greater than the second stepping distance. In other words, before moving to the starting-scan location 222 (the third block 330), the scanning module 210 moves at a longer distance and quickly close to the starting-scan location 222. After entering the area of the starting-scan location 222 (the second block 320), the scanning module 210 moves at a shorter distance and detects whether to achieve the area of the positioning location 224 (the first block 310).

In one embodiment, each block of the positioning pattern 300 has a default length and corresponds to the stepping distance of the scanning module 210 during the homing process. For example, the first stepping distance is the same as the block length of the third block 330, and the second stepping distance is the same as the block length of the first block 310 or a preset value (such as the space of 32 scan lines). The sum of the block length of the second block 320 and the third block 330 is approximately equal to the width of the scanning window 250 (in the Y direction).

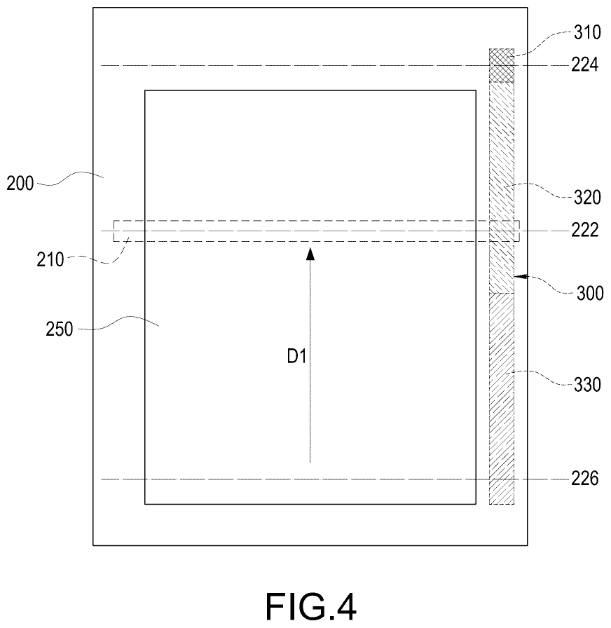

Reference is made to FIG. 4. FIG. 4 is a top view after the scanning module of FIG. 2 moves a first stepping distance. In FIG. 4, the scanning module 210 is within the area of the second block 320 after moving the first stepping distance D1. At this time, the scanning module 210 switches to moving the second stepping distance and performs the image analysis. For example, the scanning module 210 moves from the starting-scan location 222 to the positioning location 224 and continuously performs high-precision image analysis to determine whether the acquired feature of the current location is the same as the pattern feature of the first block 310.

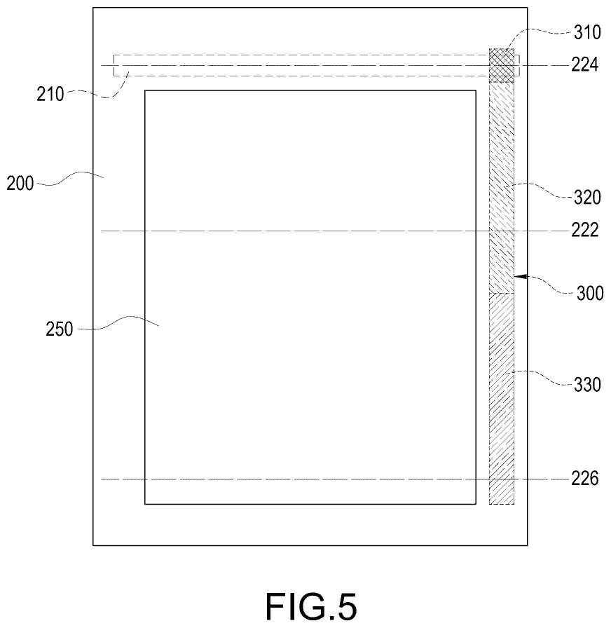

Reference is made to FIG. 5. FIG. 5 is a top view after the scanning module moves one or more second stepping distances. Following FIG. 4, the scanning module 210 continuously moves toward the positioning location 224 with a shorter distance to perform the image analysis. In the embodiment, the scanning module 210 determines that the acquired feature of the current location is the same as the pattern feature of the first block 310, so the scanning module 210 determines that the current location is at the positioning location 224 and stops at the positioning location 224.

As shown in FIG. 4 and FIG. 5, the scanning module 210 executes the pixel computation only once during the movement from the stopping-scan location 226 to the starting-scan location 222. In addition, one or more image analyses are performed during the movement from the starting-scan location 222 to the positioning location 224, and the quantity of the image analyses depends on the reading distance of the scanning module 210 (such as each moving distance of 32 scan lines with one image analysis), where the reading distance is also associated with the block length of the first block 310. In other words, when the distance between the starting-scan location 222 and the positioning location 224 is long, the distance of the scanning module 210 moving from the area of the second block 320 to the area of the first block 310 is long accordingly, and the quantity of the image analyses is also more than the quantity of the image analyses occurring when the distance between the starting-scan location 222 and the positioning location 224 is short, so it takes time to complete the homing operation.

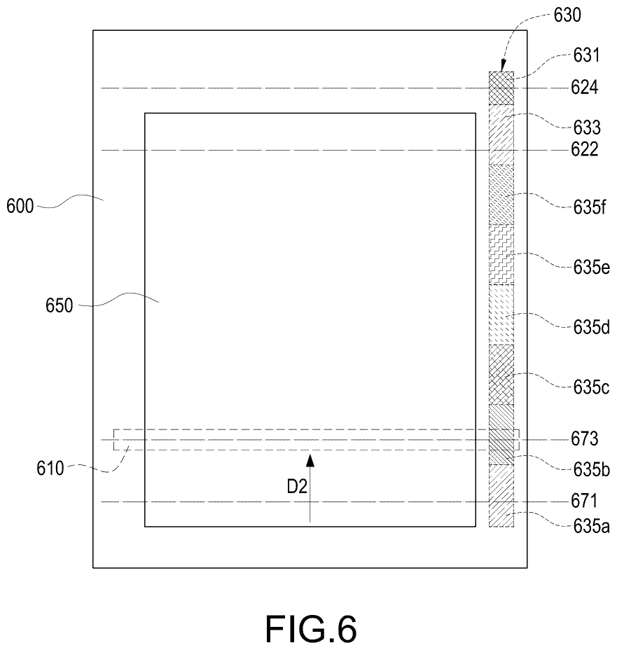

Reference is made to FIG. 6. FIG. 6 is a top view of the scanning device having the positioning pattern according to an embodiment of the disclosure.

The scanning module 610 of the scanning device 600 faces the scanning window 650 and scans the documents through the scanning window 650 according to the moving-scan cycle direction.

The positioning pattern 630 is disposed adjacently at the outer side of the scanning window 650 and the scan line of the scanning module 610 covers the width of the scanning window 650 and the width of the positioning pattern 630.

The positioning pattern 300 includes a first block 631, a second block 633, and a plurality of third block 635a to 635f. The first block 631, the second block 633, and the plurality of third block 635a to 635f are arranged in order continuously adjacent blocks with different pattern features.

In the case of the width of the positioning pattern 300 fixed, the quantity of the block of the positioning pattern 300 increases, and then the block length of each block is short. For example, there are 6 third blocks of the positioning pattern 630 in FIG. 6, and there is 1 third block of the positioning pattern 300. Hence, the block length of the third block 635a (in the case of the width of all the third blocks being the same) of FIG. 6 is shorter than the block length of the third block 330 of FIG. 2.

In one embodiment, the scanning device 600 presets the first stepping distance D2 to be the same as the block length of the third block 635a to 635f and presets the second stepping distance to be the same as the block length of the first block 631 or other values (such as the spacing of 32 scan lines). In this embodiment, the first stepping distance is greater than the second stepping distance.

As shown in FIG. 6, the scanning module 610 moves the first stepping distance D2 from the stopping-scan location 671. The location is the current location 673 after the scanning module 610 moves the first stepping distance D2. Because the first stepping distance D2 is the block length of the third block, the scanning module 610 moves to the next third block after moving the first stepping distance D2. For example, the scanning module 610 moves from the area of the third block 635a to the area of the third block 635b. In this embodiment, the positioning pattern 630 has 6 third blocks, and the scanning module 610 performs the stepping controls 6 times, at each move with the first stepping distance the same as the block length of the third block, so the scanning module 610 may move to the area of the second block 633, i.e., the starting-scan location 622.

It should be noted that the pixel computation is performed once with each stepping control. Hence, the scanning module 610 only performs the stepping controls and the pixel computations 6 times respectively to arrive at the starting-scan location 622.

From the aforementioned embodiment of FIG. 6, after arriving at the starting-scan location 622, the scanning module 610 switches to moving the second stepping distance toward the positioning location 624, with the image analysis while moving the shorter distance (relative to the first stepping distance). If the scanning module 610 determines that the acquired feature of the current location is different from the pattern feature of the first block 631, the scanning module 610 moves the second stepping distance and performs the image analysis again. If the scanning module 610 determines that the acquired feature of the current location is the same as the pattern feature of the first block 631, the scanning module 610 determines that the current location is at the positioning location 624 and stops at the positioning location 624.

In one embodiment, the pattern feature of the block may be the block color or the block width.

The block color may be applied by the color spaces such as the RGB (Red, Green, Blue) color space, the HSV (Hue, Saturation, Value) space, the HSL (Hue, Saturation, Lightness) color space, and the CMYK (Cyan, Magenta, Yellow, Key (Black) color space.

All the blocks of the positioning pattern 630 are preset with corresponding colors. The following statement takes the HEX color space as an example. The block color of the first block 631 is FFFFFF (white), the block color of the second block 633 is 000000 (black), the block color of the third block 635a is FFFF00 (yellow), the block color of the third block 635b is FF00FF (magenta), the block color of the third block 635 c is 00FFFF (cyan), the block color of the third block 635 d is FF 0000 (red), the block color of the third block 635 e is 00FF00 (green), and the block color of the third block 635 f is 0000FF (blue).

In one embodiment, the color distance between the block color of the third block 635f and the block color of the second block 633 is greater than a threshold. By designing the block colors with great color difference, the scanning module 610 may quickly complete the image analysis and reduce the errors caused by the image analysis error, so both the efficiency and the accuracy are simultaneously improved.

In another embodiment, the first block 631, the second block 633, and the plurality of the third blocks 635a to 635f are the blocks with different block lengths. The scanning device 600 stores the block colors and the block lengths of the first block 631, the second block 633, and the plurality of the third blocks 635a to 635f in advance. When moving to one of the blocks, the scanning module 610 determines the corresponding block of the current location by the acquired feature, and then the corresponding block is taken as the first stepping distance. For example, when the scanning module 610 determines that the current location is at the third block 635e, the scanning module 610 sets the block length of the third block 635e to be the first stepping distance and moves the first stepping distance toward the positioning location 724.

In one embodiment, the first block 631 is a block having a special pattern. When the scanning module 610 moves to the area of the first block 631, the scanning module 610 performs the image analysis to determine whether any special pattern is acquired. If the special pattern (e.g., the whole special pattern) is acquired, it represents that the scanning module 610 has moved at the positioning location and the homing operation is completed. In one embodiment, if the scanning module 610 does not acquire the special pattern, the scanning module 610 keeps moving the first stepping distance until the special pattern (e.g., the whole special pattern) is acquired.

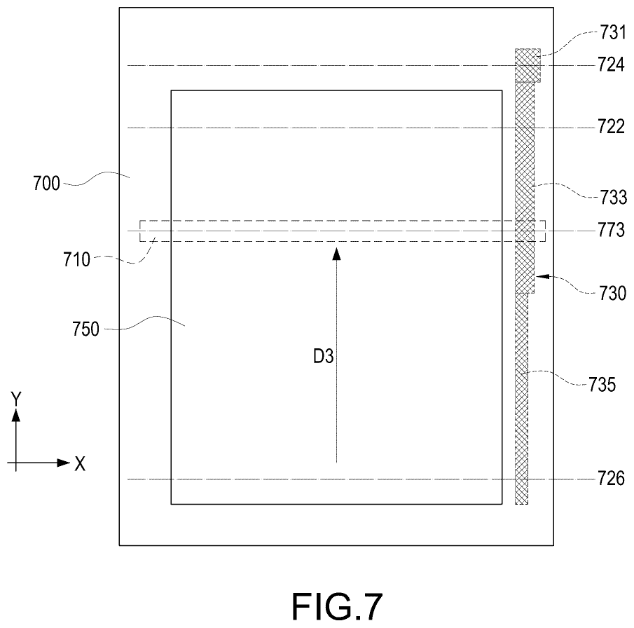

FIG. 7 is a top view of the scanning device having the positioning pattern according to another embodiment of the disclosure.

The positioning pattern 730 is disposed at the outside of the scanning window 750, and the scan line of the scanning module 710 covers the width of the scanning window 750 and the width of the positioning pattern 730.

Compared with the positioning patterns 300 and 630 are designed to have different block colors, the positioning pattern 730 is designed to have different block widths. In this embodiment, the scanning module 710 analyzes the block width of the image to be the pattern feature of the current location.

The positioning pattern 730 includes a first block 731, a second block 733, and a third block 735, and the first block 731, the second block 733, and the third block 735 respectively have a block width (in the X direction). In one embodiment, the block width first block 731 of the first block 731 is greater than the block width of the second block 733, and the block width of the second block 733 is greater than the block width of the third block 735.

The user may set the block widths of the first block 731, the second block 733, and the third block 735 in advance and store the records in the scanning device 700. For example, the block width of the first block 731 is 30 pixels, the block width of the second block 733 is 20 pixels, and the block width of the third block 735 is 10 pixels.

In the operation of the scanning device 700 performing the homing process of the scanning module 710, the scanning module 710 is positioned at the stopping-scan location 726 after completing the scanning process. Then the scanning module 710 moves the first stepping distance D3 (such as the block length of the third block 735) toward the positioning location 724 and performs the image analysis to detect the acquired feature (such as the block of 20 pixels width) of the current location 773 of the scanning module 710. If the acquired feature of the current location 773 is the same as the pattern feature of the second block 733, the scanning module 710 switches to moving the second stepping distance toward the positioning location 724 and performs the image analysis to detect the acquired feature (such as the block with 30 pixels width) of the current location of the scanning module 710. If the acquired feature of the current location is the same as the pattern feature of the first block 731, the scanning module 710 determines that the current location is positioned at the positioning location 724 and stops at the positioning location 724, so the homing operation is completed.

From all the embodiments stated above, the disclosure provides the positioning patterns (300, 630, 730) being respectively arranged at the outer side of the scanning windows (250, 650, 750), and the scan lines of the scanning modules (210, 610, 710) cover the width of the scanning windows (250, 650, 750) and the width of the positioning patterns (300, 630, 730). Hence, the existing but unused outer space of the positioning patterns (300, 630, 730) and the tail end of the scanning module (210, 610, 710) are used to effectively utilize the scanning module (i.e., the scanning module has the section exceeding the scanning window and the section is not utilized to perform the scanning process) and achieve the function of positioning.

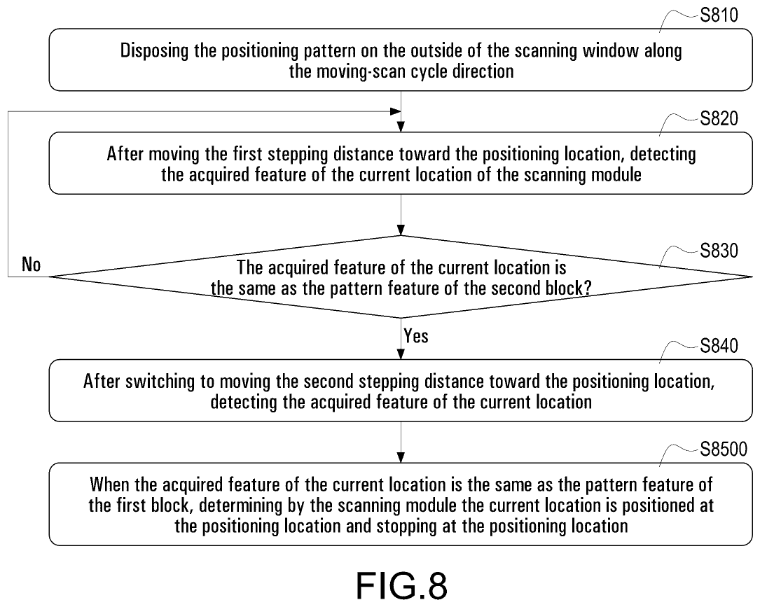

FIG. 8 is a flowchart of a homing method of the scanning device according to an embodiment of the disclosure. The scanning device of any of the embodiments above performs the homing method of FIG. 8, so the scanning module returns to the fixed positioning location after the scanning module finishes the scanning process.

In step S810, disposing the positioning pattern on the outside of the scanning window along the moving-scan cycle direction is performed.

In step S820, after the scanning module moves the first stepping distance toward the positioning location, detecting the acquired feature of the current location of the scanning module is performed.

In step S830, determining by the scanning module whether the acquired feature of the current location is the same as the pattern feature of the second block is performed. If the determination is positive, the process goes to step S840. If the determination is negative, it indicates that the current location of the scanning module is still positioned at the area of the third block, and the process goes back to step S820 to continue the movement of the first stepping distance and the image analysis.

In step S840, after the scanning module switches to moving the second stepping distance toward the positioning location, detecting the acquired feature of the current location is performed.

In step S850, when the acquired feature of the current location is the same as the pattern feature of the first block, determining by the scanning module the current location is positioned at the positioning location and stopping at the positioning location is performed. At this time, the scanning module completes the homing operation.

As stated above, the disclosure provides the scanning device and the homing method of the scanning device to dispose the positioning pattern on the scanning device and determine the current location of the scanning module by analyzing the pattern feature of the positioning pattern. Because the image analysis is eliminated when the scanning module moves from the stopping-scan location to the starting-scan location, and only the simple computation of the pixel values is required, the scanning module may quickly move toward the positioning location from a location far away from the positioning location. Hence, the movement time of the scanning module is significantly decreased. In addition, the scanning module moves to the location near the positioning location and then performs the short-distance movement and the image analysis, incorporated with the design of the pattern feature of the block of the positioning pattern, the scanning module may accurately determine whether the homing process of the scanning module is completed.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A scanning device, comprising:
a scanning module, moving along a moving-scan cycle direction; and
a positioning pattern, disposed on outside of a scanning window along the moving-scan cycle direction, wherein the positioning pattern comprises a first block, a second block, and at least one third block, the first block is associated with a positioning location, the second block is associated with a starting-scan location, and the first block, the second block and the at least one third block are consecutive adjacent blocks with different pattern features;
wherein after the scanning module moves a first stepping distance toward the positioning location, an acquired feature of a current location is detected, and when the acquired feature of the current position is same as the pattern feature of the second block, the scanning module switches to moving a second stepping distance toward the positioning location to detect the acquired feature of the current location, and when the acquired feature of the current position is same as the pattern feature of the first block, the scanning module determines the current location is the positioning location and stops at the positioning location.

2. The scanning device of claim 1, wherein a length of a scan line of the scanning module is greater than a width of the scanning window, and the scanning module scans a section outside of the scanning window comprising the positioning pattern.

3. The scanning device of claim 1, wherein when the scanning module is positioned at an area of the at least one third block, the scanning module determines a corresponding block of the current location according to the acquired feature and sets a block length of the corresponding block to be the first stepping distance.

4. The scanning device of claim 1, wherein the second block and the at least one third block of the scanning module have same block length.

5. The scanning device of claim 1, wherein the pattern feature of the first block, the second block, and the at least one third block is a block color or a block width.

6. A homing method of a scanning device, wherein the scanning device comprises a scanning module moving along a moving-scan cycle direction, and the homing method comprises:
disposing a positioning pattern on outside of a scanning window along the moving-scan cycle direction, wherein the positioning pattern comprises a first block, a second block, and at least one third block, the first block is associated with a positioning location, the second block is associated with a starting-scan location, and the first block, the second block, and the at least one third block are consecutive adjacent blocks with different pattern features;
moving by the scanning module a first stepping distance toward the positioning location and detecting an acquired feature of a current location of the scanning module;
determining by the scanning module whether the acquired feature of the current location is same as the pattern feature of the second block and switching to moving a second stepping distance toward the positioning location to detect the acquired feature of the current location; and
determining by the scanning module the acquired feature of the current location being same as the pattern feature of the first block, and determining the current location being at the positioning location to stop at the positioning location.

7. The homing method of claim 6, wherein a length of a scan line of the scanning module is greater than a width of the scanning window, and the scanning module scans a section outside of the scanning window comprising the positioning pattern.

8. The homing method of claim 6, wherein the first stepping distance of the scanning module is same as the block length of the at least one third block.

9. The homing method of claim 6, wherein when the scanning module moves to an area of the at least one third block, the homing method comprises determining a corresponding block of the current location according to the acquired feature and setting a block length of the corresponding block to be the first stepping distance.

10. The homing method of claim 6, wherein the pattern feature of the first block, the second block, and the at least one third block is a block color or a block width.
